(19) United States
(12) Patent Application Publication
(10) Pub. No.: US 2009/0073195 A1
(43) Pub. Date: Mar. 19, 2009

(54) Rotary printing device

(75) Inventor: Chizuo Ozawa, Shiojiri-shi (JP)

Correspondence Address: BUCHANAN, INGERSOLL & ROONEY PC, POST OFFICE BOX 1404, ALEXANDRIA, VA, 22313-1404, US

(73) Assignee: MASTERMIND CO., LTD., Shiojiri-shi (JP)

(21) Appl. No.: 11/902,045

(22) Filed: Sep. 18, 2007

(51) Int. Cl. B41J 3/00; B05C 17/06

(52) U.S. Cl. 347/4; 101/126

(57) ABSTRACT

In a rotary printing device, six printing racks disposed at equal angular intervals on the same circle revolve via the printing positions of six printing units arranged at equal angular intervals on the same circle. Five of the printing units are screen printing machines for printing designs and other matter common to the T-shirts. The remaining printing unit is an inkjet printer whereby the wearers' names and other types of individual information specific to each T-shirt are printed on the T-shirts. A highly versatile printing device capable of printing names and other individual information on T-shirts can be attained.

### TECHNICAL FIELD

The present invention relates to a rotary printing device suitable for printing the wearer's name and other individual information as well as designs on T-shirts, pants, and other garments.

### RELATED ART

In printing of T-shirts, pants, and other garments, as well as towels and other textiles, a number of screen versions are produced corresponding to the print colors, and overprinting is carried out on the surface of the textiles using the screen versions corresponding to each of the print colors.

Rotary screen printing devices have been proposed in which, in order to carry out multicolored printing with good efficiency using screen printing machines, a screen printing machine comprising a screen and a squeegee is disposed in a radial manner, and multicolored printing is carried out while a plurality of printing racks are made to intermittently revolve along a revolving path via positions in which printing is performed by the screen printing machine. Screen printing devices having this configuration are disclosed in patent documents 1 and 2.

[Patent Document 1] JP-A 10-278224.

[Patent Document 2] JP-A 2002-67271.

It has been suggested that a large quantity of T-shirts having the same design can be printed using a rotary screen printing device. However, even when the design is the same, the screen versions must be replaced and the number of types of screen versions increased in cases in which different types of information or patterns, such as the wearers' name, consecutive numbers, or other designations, are imprinted on each T-shirt. Therefore, conventional rotary screen printing devices are efficient when printing the same design, but are not suitable when imprinting different information or patterns on each shirt, and present problems in terms of low versatility and high cost.

### SUMMARY OF THE INVENTION

With the foregoing problems in view, it is an object of the present invention to provide a highly versatile rotary printing device which can carry out printing with good efficiency even when different types of information and patterns are imprinted on each textile.

In order to solve the above problems, the rotary printing device of the present invention is characterized in comprising a plurality of printing racks disposed at prescribed angular intervals on a circumference about a common rotary axis, and a plurality of printing units disposed in positions above the printing racks at prescribed angular intervals on a circumference about the common rotary axis; wherein at least one of the printing units is an inkjet printer, and the remaining printing units are screen printing machines; and wherein the plurality of printing racks and the plurality of printing units are rotated relative to each other about the common rotary axis, the printing racks are successively positioned at positions wherein printing is performed by the printing units, and printing is carried out on textiles placed on the printing racks.

For example, the printing units are disposed at fixed positions, and the printing racks are caused to revolve intermittently and to successively move to the printing position of each of the printing units. Printing is carried out by each of the printing units on the T-shirts or other textiles placed on the printing racks. When the printing racks have passed through all of the printing units, the printing of the textiles is complete.

In a design to be printed on the textiles, elements common to each textile can be printed by a screen printing machine. Information, designs, or other elements specific to each textile can be printed by an inkjet printer. Specifically, in a screen printing machine, an available screen is affixed and, in order to change the print design or other elements, it is necessary to change the screen. However, in an inkjet printer, the printing information can be readily modified or corrected on a host controller such as a personal computer. Therefore, the printing operation can be carried out with good efficiency even in the case of printing names, consecutive numbers, or other information on T-shirts and other garments, i.e., even when the printing information is different for each textile.

One of the abovementioned screen printing machines can be made to be a pretreatment screen printing machine used to apply a pretreatment agent to the entire surface of the printing area of the textile.

One of the abovementioned screen printing machines can be made to be a screen printing machine used to apply white ink to the entire surface of the printing area of a substrate.

Yet another possible option is to arrange at least two inkjet printers and to use one of the inkjet printers to apply white ink to the entire surface of the printing area of the textile.

Next, only the inkjet printers can be made to move along the different pathways of movement. The rotary printing device in this case is characterized by comprising a plurality of printing racks able to revolve on a circumference about a common rotary axis; a plurality of screen printing units disposed in positions above the printing racks at prescribed angular intervals on a circumference about the common rotary axis; and at least one inkjet printer capable of movement between a printing position in which printing can be carried out on textiles that are advanced to positions above the revolving path of the abovementioned printing racks and are placed on the printing racks, and a retracted printing position withdrawn from the print position; wherein the plurality of printing racks are intermittently revolved, positioned at positions where printing is performed by the inkjet printers and screen printing units, and used to carry out printing on the textiles placed on the printing racks.

In the rotary printing device of the present invention, different types of printing information can be printed on each textile by the inkjet printers.

One of the screen printing machines can be made to be a pretreatment screen printing machine used to apply a pretreatment agent to the entire surface of the printing area of the textile. One of the screen printing machines can be made to be a screen printing machine used to apply white ink to the entire surface of the printing area of the substrate. Yet another possible option is to arrange at least two inkjet printers and to use one inkjet printer to apply white ink to the entire surface of the printing area of the textile.

As described above, in the rotary printing device of the present invention, printing information common to the substrates is printed by screen printing machines, and printing information specific to each substrate is printed by inkjet printers. Therefore, even in the case of printing names, consecutive numbers, and other designations on T-shirts and other garments, printing can be carried out with the same production performance as conventional rotary screen printing devices. In this way, a highly versatile printing device suitable for the printing of T-shirts and other garments, as well as textiles and the like can be realized.

### BRIEF DESCRIPTION OF THE DRAWINGS

FIG. 1A is a diagram of a rotary printing device to which the present invention is applied;

FIG. 1B is a diagram showing a screen printing machine of the rotary printing device of FIG. 1A;

FIG. 1C is a diagram showing an inkjet printer of the rotary printing device of FIG. 1A;

FIG. 2A is a plan view showing another example of a rotary printing device to which the present invention is applied;

FIG. 2B is an elevation view of the rotary printing device of FIG. 2A.

### DETAILED DESCRIPTION OF THE PREFERRED EMBODIMENTS

Below, the rotary printing device to which the present invention is applied is described with reference to the accompanying drawings.

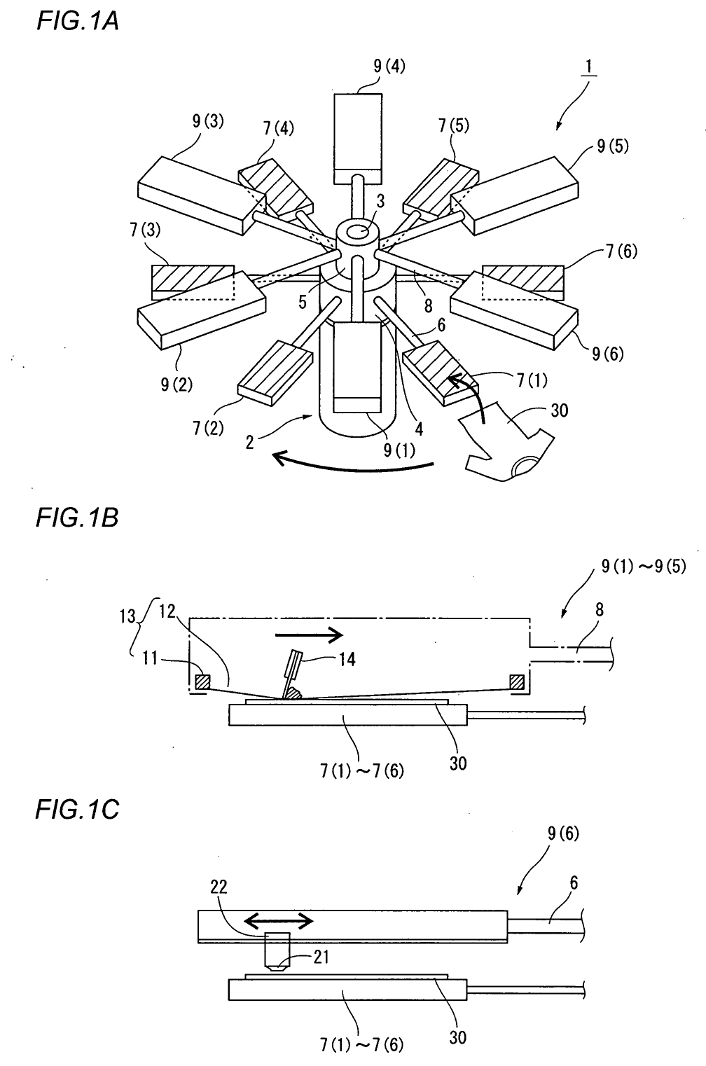

FIG. 1A is a diagram showing the entire configuration of a rotary printing device to which the present invention is applied. The rotary printing device 1 comprises an apparatus stand 2, a lower rotating wheel 4 rotatably supported by the apparatus stand 2 about a rotary central axis 3, and an upper rotating wheel 5 rotatably supported in the same manner as the lower rotating wheel 4 about the rotary central axis 3. Support arms 6 are extended in a radial pattern in the horizontal direction at regular angular intervals from the peripheral surface of the lower rotating wheel 4. In the present example, six support arms 6 are extended in a radial pattern at angular intervals of 60°. Rectangular printing racks 7(1) to 7(6) are attached horizontally on each of the end portions of the support arms 6. Substrates, e.g., T-shirts, are held immobile on the horizontal mounting surfaces (the surfaces indicated in the diagram by diagonal lines) of the printing racks 7(1) to 7(6).

Support arms 8 are also extended in a radial pattern in the horizontal direction at regular angular intervals from the peripheral surface of the upper rotating wheel 5. In the present example, six support arms 8 are extended in a radial pattern at angular intervals of 60°. Printing units 9(1) to 9(6) are attached to the end portions of the support arms 8. The printing units 9(1) to 9(5) are screen printing machines, while the remaining printing unit 9(6) is an inkjet printer. It is apparent that the plurality of printing units may be inkjet printers.

As shown in FIG. 1B, each of the screen printing machines 9(1) to 9(5) comprises a screen plate 13 composed of a screen 12 stretched over a rectangular screen frame 11, as well as a squeegee 14 and an ink supply part and a squeegee driving part (not shown).

As shown in FIG. IC, the inkjet printer 9(6) comprises, for example, a line inkjet head 21 having a prescribed width, and a head carriage 22 for causing the line inkjet head 21 to perform reciprocating movement.

In the rotary printing device 1 of this configuration, the printing racks 7(1) to 7(6) and the printing units 9(1) to 9(6) can be revolved independently by a drive mechanism (not shown). By being caused to revolve relative to each other, the printing racks 7(1) to 7(6) can be moved successively to each position in which printing is performed by the printing units 9(1) to 9(6).

Next, the printing operation of the rotary printing device 1 is described. The following description is of the printing operation when the printing units 9(1) to 9(6) are made to be stationary, and the initial position of the printing racks 7(1) to 7(6) is an angular position offset by 30° relative to the printing units 9(1) to 9(6). A substrate, e.g., a T-shirt 30, is first supplied to and fixed on the mounting surface of the printing rack 7(1) by a supply mechanism (not shown).

Next, the printing racks 7(1) to 7(6) are caused to revolve 30°. As a result, the printing racks 7(1) to 7(6) reach the printing positions of the printing units 9(1) to 9(6). Screen printing is carried out on the T-shirt 30 of the printing rack 7(1) by the printing unit 9(1). For example, a pretreatment agent is applied to the entire printing area of the surface of the T-shirt 30. Afterwards, the printing racks 7(1) to 7(6) are caused to revolve 30°, the printing rack 7(6) is positioned at the T-shirt supply position, and the T-shirt 30 is supplied.

Next, the printing racks 7(1) to 7(6) are caused to revolve 30° and are positioned at the printing positions of the printing units 9(2), (3), . . . , (6), and (1), and screen printing is carried out respectively by the printing units 9(2) and 9(1) on the T-shirts 30 placed on the printing racks 7(1) and 7(6). For example, white ink is applied by the printing unit 9(2) to the entire surface of the application area of the pretreatment agent applied to a T-shirt. By applying white ink to create a white base, a color image can be printed by the printing units 9(3) to 9(6) on the printing area of the T-shirt without being affected by the color of the T-shirt. Thereafter, the printing racks 7(1) to 7(6) are caused to revolve intermittently by 30° intervals, and the supplying of T-shirts and the printing operation are repeated.

The printing units 9(1) to 9(5) print the printing information common to all of the T-shirts. In contrast, when a T-shirt 30 placed on the printing rack 7(1) reaches the position for printing by the last printing unit 9(6), different information can be printed on each T-shirt because the printing unit 9(6) is an inkjet printer. In the present example, the name of the wearer or the garment's owner may be printed.

When revolved 30° following printing by the printing unit 9(6), the printing rack 7(1) is returned again to the T-shirt supply position. A supply operation in which the printed T-shirt is removed from the printing rack and a new T-shirt is supplied is subsequently carried out for each printing rack.

It is also possible to keep the printing racks 7(1) to 7(6) in a stationary state, cause the printing units 9(1) to 9(6) to revolve, and perform printing. Printing can also be carried out while both are caused to revolve intermittently in opposite directions. It is also possible to adopt a configuration that includes two or more inkjet printers as the printing units. Finally, in the present example, the number of printing racks and the number of printing units are the same, but it is also possible for the numbers to be different.

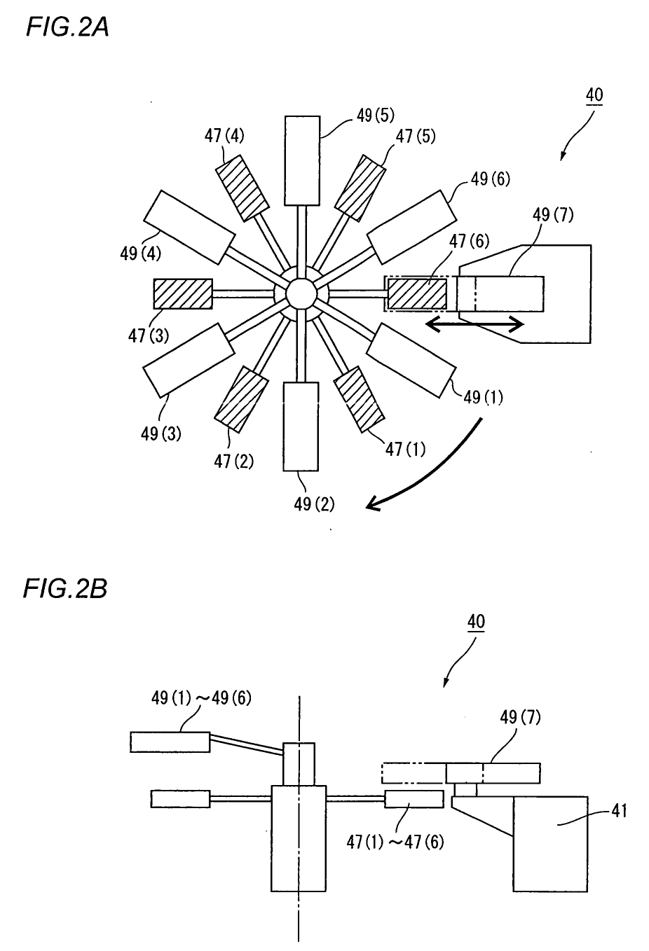

Next, FIGS. 2A and 2B are respectively a plan view and an elevation view of another example of a configuration of a rotary printing device to which the present invention is applied. In the rotary printing device 40 of the present example, printing racks 47(1) to 47(6) are caused to revolve along the same circle, and printing units 49(1) to 49(6), which are screen printing machines, are kept stationary. The revolving action of the printing racks is the same as in the example above. The printing unit 49(7), which is an inkjet printer, can be mounted onto a slide mechanism 41 and can slide between a print position A, in which printing can be carried out on a T-shirt placed on one of the printing racks at revolving positions offset by 30° from the adjacent positions where the printing units 49(1) to 49(6) are positioned, and a retracted position B withdrawn from the print position A.

In the rotary printing device 40, the printing racks are caused to revolve intermittently by 30° intervals, and screen printing is carried out by the printing units 49(1) to 49(6) without using the printing unit 49(7) when there is no need to print different printed information on each T-shirt. When different printed information is printed on each T-shirt, the printing unit 49(7) is driven and individual information is printed on the T-shirts on the printing racks. The printing operation performed by the inkjet printer can be carried out using the operating time in which a T-shirt for which printing has been completed is removed from a printing rack, and a fresh T-shirt is supplied. Accordingly, the cycle time of the entire printing process can be kept constant even in the case of individual information being printed. Therefore, a high-productivity printing operation can be carried out.

A printing unit having the same configuration as the printing unit 49(7) can be further added to the rotary printing device 40. The additional printing unit is adapted to be able to slide between a revolving position offset by 60° from the printing unit 49(7), i.e., the print position in which printing can be carried out on the T-shirt placed on the printing rack at the revolving position of the printing rack 47(1) in FIG. 2A; and a retracted position withdrawn from the print position in a radial direction. When white ink is applied to the entire printing area of the T-shirt by the additional printing unit, a color image can be printed by the subsequent printing units without being affected by the color of the T-shirt. When applying white ink to the T-shirt is unnecessary, the printing racks may be caused to revolve intermittently by 30° intervals without using the additional printing unit, screen printing may be carried out by the printing units 49(1) to 49(6), and printing may be carried out by the printing unit 49(7).

1. A rotary printing device comprising:
a plurality of printing racks disposed at prescribed angular intervals on a circumference about a common rotary axis; and
a plurality of printing units disposed in positions above the printing racks at prescribed angular intervals on a circumference about the common rotary axis; wherein
at least one of the printing units is an inkjet printer, and the remaining printing units are screen printing machines; and wherein
the plurality of printing racks and the plurality of printing units are rotated relative to each other, the printing racks are successively positioned at positions wherein printing is performed by the printing units, and printing is carried out on substrates placed on the printing racks.

2. The rotary printing device of claim 1, wherein
the screen printing machines print information common to all substrates; and
the inkjet printer prints information specific to each of the substrates.

3. The rotary printing device of claim 1, wherein one of the screen printing machines is a pretreatment screen printing machine used to apply a pretreatment agent to an entire surface of a printing area of a substrate.

4. The rotary printing device of claim 1, wherein one of the screen printing machines is a screen printing machine used to apply white ink to an entire surface of a printing area of a substrate.

5. The rotary printing device of claim 1, comprising at least two inkjet printers, wherein one of the inkjet printers is used to apply white ink to an entire surface of a printing area of a substrate.

6. A rotary printing device comprising:
a plurality of printing racks able to revolve on a circumference about a common rotary axis;
a plurality of screen printing units disposed in positions above the printing racks at prescribed angular intervals on a circumference about the common rotary axis; and
at least one inkjet printer capable of movement between a printing position in which printing can be carried out on substrates that are advanced to positions above a revolving path of the printing racks and are placed on the printing racks, and a retracted printing position withdrawn from the printing position; wherein
the plurality of printing racks are intermittently revolved, positioned at positions in which printing is performed by the inkjet printers and screen printing units, and used to carry out printing on substrates placed on the printing racks.

7. The rotary printing device of claim 6, wherein the screen printing machines print information common to all substrates; and
the inkjet printer prints information specific to each of the substrates.

8. The rotary printing device of claim 6, wherein one of the screen printing machines is a pretreatment screen printing machine used to apply a pretreatment agent to an entire surface of a printing area of a substrate.

9. The rotary printing device of claim 6, wherein one of the screen printing machines is a screen printing machine used to apply white ink to an entire surface of a printing area of a substrate.

10. The rotary printing device of claim 6, comprising at least two inkjet printers, wherein one of the inkjet printers is used to apply white ink to an entire surface of a printing area of a substrate.
